(19) United States
(12) Patent Application Publication
(10) Pub. No.: US 2006/0080275 A1
(43) Pub. Date: Apr. 13, 2006

(54) Digital file consumer information methods and devices

(76) Inventor: Dean Vegas Christal, Santa Barbara, CA (US)

Correspondence Address: Craig Barber, PO Box 16220, Golden, CO, 80402-6004, US

(21) Appl. No.: 11/101,387

(22) Filed: Apr. 8, 2005

Related U.S. Application Data
(62) Division of application No. 10/963,917, filed on Oct. 12, 2004.

(51) Int. Cl. G06F 17/30

(52) U.S. Cl. 707/1

(57) ABSTRACT

A vending machine and vending method for audio, video, music, movie or other date file downloads is optimized for commercial viability and product placement. The vending machine offers standard connectors allowing users to access a library of download files and download those files to data players such as MP3 music download players, video players and so on. It further offers inexpensive data players to users in addition to offering downloads. Importantly, the device has hardware or software (video) softbuttons allowing remote reprogramming: in the product placement method of the invention, a commercial entity may pay to have the softbutton programmed to their desired data file source. Commercial entities buying placement on the vending machine may be artists, performers, studios, recording labels, on-line and other music libraries. The machine may accept coins, thus increasing saleability of the data products sold thereon.

### CROSS-REFERENCE TO RELATED APPLICATIONS

This application is a division of and claims the benefit and filing date of parent application Ser. No. 10/963,917 filed in the United States patent and Trademark Office on Oct. 12^{th}, 2004, with the title DIGITAL FILE CONSUMER GOOD PROMOTION METHOD AND VENDING MACHINE DEVICE in the name of the same inventor, Dean Vegas Christal for which the entire disclosure is incorporated by reference.

### FIELD OF THE INVENTION

This invention relates generally to vending devices for digital files and specifically to methods of promotion of digital file consumer goods such as audio, video and data files.

### STATEMENT REGARDING FEDERALLY FUNDED RESEARCH

This invention was not made under contract with an agency of the US Government, nor by any agency of the US Government.

### BACKGROUND OF THE INVENTION

It is now well known that audio, video and digital files may be downloaded from Internet based services to home computers and thereafter downloaded to small portable player devices. The presently most popular form of this is the MP3 player, however, video content and data content may be so downloaded as well.

Less well known is the race to develop a commercially successful vending machine allowing this process. However, work is on-going in this area and the following list of patents shows the great interest in this.

Most such devices concentrate upon the fundamental transfer and pay relatively less attention to successful commercialization of the concept. In particular, as of the date of application there has not yet been a commercially successful effort to vend digital music or video, despite attempts dating back at least five years. No known system allows the user to successfully gather a wide range of consumer information at a point of sale located in a commercial establishment.

Patentability searching in the field yields a number of references.

US Patent Publication No. 2004/0086120 published May 6, 2004 in the name of Akins, III et al, teaches a satellite TV system for downloads and management thereof, and therefore teaches away from any vending related system of downloads.

US Patent Publication No. 2003/0061301 published Mar. 27^{th}, 2003 in the name of Chethik et al teaches a stereo system for downloads and management thereof, and therefore has the same problem that it teaches away from any vending related system of downloads.

US Patent Publication No. 2002/0069127 published Jun. 6, 2002 in the name of Enari teaches a method of acquiring file identification codes in order to speed purchases. The device teaches that a telephone may be used to acquire the codes prior to purchase at a store, thus teaching away from any vending machine or product placement.

US Patent Publication No. 2002/0042777 published Apr. 11, 2002 in the name of Yoshida et al teaches a method of providing credit in a recording medium.

U.S. Pat. No. 6,799,084 published Sep. 28, 2004 in the name of Grobler teaches a device for providing a CD or other known media format with music downloads or the like, and thus teaches away from use of a vending device or actual data player. It is also silent regarding methods of product promotion.

U.S. Pat. No. 6,779,115 published Aug. 17, 2004 in the name of Naim teaches use of a smart card for identity and credit determination of the user.

U.S. Pat. No. 6,711,464 published Mar. 23, 2004 in the name of Yap et al teaches a CD vending system and thus teaches away from use of MP3 players or product promotion methods.

U.S. Pat. No. 6,594,548 published Jul. 15, 2002 in the name of Bagnordi teaches use of PDAs, ebooks and smart cards to receive non-audio-video format works. It does not teach any methods of business development.

U.S. Pat. No. 6,567,847 published May 20, 2003 in the name of Inoue teaches a network system for allowing users to lay open their own works for public perusal. It does not as such deal with product placement nor promotion otherwise.

U.S. Pat. No. 6,535,791 published Mar. 18, 2003 in the name of Wang teaches a vending method directed towards printed materials, and thus teaches away from transfer of data files to the player of a user.

U.S. Pat. No. 6,507,727 published Jan. 14, 2003 in the name of Henrick teaches a method of identifying or securing music heard on broadcast radio stations.

U.S. Pat. No. 6,330,490 published Dec. 11, 2001 in the name of Kim et al teaches vending of traditional magnetic or optical devices of traditional CD or audio tape type, and does not deal with promotion of products.

U.S. Pat. No. 5,781,889 published Jul. 14, 1998 in the name of Martin et al teaches a method of managing a network of “jukebox” style music players, and thus teaches away from commercial downloads.

U.S. Pat. No. 5,768,142 published Jun. 16, 1998 in the name of Jacobs teaches towards “expert” or relational suggestion of choices of files to users based upon the users' past buying choices. It thus teaches away from product promotion driven by commercial considerations.

One aspect of the changing situation which references appear to have overlooked is the commercial result of the impending drop in the price of such MP3 players. For example, at the time of filing, one major player in the industry intends to market an MP3 player for a cost in the range of only $25.00 USD. This allows further methods of promotion of digital file downloads as a commercially vendable product.

It is also worth noting that there is a “convergence” occurring in the player market. A “player” may be a cellular telephone, a game player, a PDA or another device, but it may also be increasingly common combinations of these devices.

It is also important to be aware that increasing numbers of retailers, distributors, manufacturers and financial groups are seeking an increased database of information regarding the consumer as an individual. Information about the preferences of individual consumers is now recognized as a valuable commodity itself. Various attempts have been made to gain this information. One well known example is the use of “store cards” which provide consumers with the sale price on groceries, but which identify the consumer by name whenever the card is used to make a purchase.

The Internet, the primary medium to date for digital file sale, may be used to automatically collect such information. However, the Internet itself has disadvantages as a sales tool. Users must be online and willing to purchase items in that manner. This discounts the likelihood of “impulse purchases”, co-branding, co-marketing, gift offers and so on, and furthermore skews the demographics of the likely consumer population.

It would be advantageous to provide a method of selling digital consumer products (music files, game files, video files, etc) directly to consumers in locations and contexts other than the Internet, and to allow co-marketing, impulse purchasing, and surveys of the consumers either collectively or as individuals.

Finally, on-line copyright piracy has been a significant problem. It would be preferable to provide users, especially young users, with a convenient, appealing and legal forum for file downloads.

### SUMMARY OF THE INVENTION

General Summary

The present invention teaches that a vending machine for digital files may be used to promote the products of an advertiser desiring prominent placement of their products on the vending machine, and thus teaches a product promotion method. The device and method relate to sales of audio, video, music, music videos, movie or other date file downloads and is optimized for commercial viability and product placement. The vending machine offers standard connectors allowing users to access a library of download files and download those files to data players such as MP3 music download players, video players and so on. It further offers data players (which may be inexpensive data players or top of the line models) to users in addition to offering downloads. Importantly, the device has hardware or software (video) softbuttons allowing remote reprogramming: in the product placement method of the invention, a commercial entity may pay to have the softbutton programmed to their desired data file source. Commercial entities buying placement on the vending machine may be artists, performers, studios, recording labels, on-line and other music libraries. The method may be carried out by placement of the machine in public places or in music stores having external POS stations.

The method of the invention teaches that a player may be the selected target of the file download, rather than a media device, in order to increase the desirability and instant gratification offered by the device.

Also of importance, the machine may accept coins, thus increasing saleability of the data products sold thereon.

Finally, the machine assists with control of copyrighted material and preventing illegal downloading, by providing a convenient, appealing and legal forum for file purchase.

Summary in Reference to Claims It is therefore a first aspect, advantage, objective, and embodiment of the present invention to provide a method of gathering information from consumers comprising the steps of:
a) providing to such consumers a vending machine having a data file output device;
b) establishing an operative connection between the data file output device and a desired data file;
c) downloading the desired data file to the data output device; and
d) obtaining from such consumers information.

It is therefore a second aspect, advantage, objective, and embodiment of the present invention to provide a method of gathering information from consumers further comprising the step of:
d1) obtaining from such consumers information specifically relating to the data file downloaded.

It is therefore a third aspect, advantage, objective, and embodiment of the present invention to provide a method of gathering information from consumers further comprising the step of:
a1) providing such vending machine at an establishment offering consumer goods;
d2) obtaining from such consumers information specifically relating to the consumer goods of the establishment.

It is therefore another aspect, advantage, objective, and embodiment of the present invention to provide a method of gathering information from consumers comprising the step of:
d3) obtaining from such consumers information specifically relating to such consumer.

It is therefore another aspect, advantage, objective, and embodiment of the present invention to provide a method of gathering information from consumers further comprising the step of:
d4) obtaining such information by means of a consumer survey.

It is therefore another aspect, advantage, objective, and embodiment of the present invention to provide a method of gathering information from consumers further comprising the step of:
e) associating such information with a specific consumer identity.

It is therefore another aspect, advantage, objective, and embodiment of the present invention to provide a method of gathering information from consumers further comprising the step of:
f) offering to such consumer a secondary commercial reward.

It is therefore another aspect, advantage, objective, and embodiment of the present invention to provide a method of promoting a desired data file source from a commercial entity, comprising:
a) accepting from such commercial entity identification of such desired data file source;
b) providing a vending machine;
c) providing upon the vending machine a programmable product placement control and a data file output device;
d) programming the programmable product placement control to establish an operative connection between the data file output device and the desired data file source when activated; and
e) downloading at least one data file from the desired data file source to the data output device.

It is therefore yet another aspect, advantage, objective, and embodiment of the present invention to provide a method further comprising the step of:
b2) providing the vending machine in a public place.

It is therefore yet another aspect, advantage, objective, and embodiment of the present invention to provide a method further comprising the steps of:
b2a) providing the vending machine in a store having a point of sale station,
f) receiving payment for the download.

It is therefore another aspect, advantage, objective, and embodiment of the present invention to provide a method further comprising the step of:
b3) providing the vending machine with a payment mechanism capable of accepting coins.

It is therefore another aspect, advantage, objective, and embodiment of the present invention to provide a method further comprising the step of:
b4) providing the vending machine with a payment mechanism capable of accepting paper currency.

It is therefore another aspect, advantage, objective, and embodiment of the present invention to provide a method further comprising the step of:
b5) providing the vending machine with a payment mechanism capable of accepting credit on devices scanned by the payment mechanism.

It is therefore another aspect, advantage, objective, and embodiment of the present invention to provide a method further comprising the steps of:
b6) providing the vending machine with an internal stock of data file players having ports allowing operative data connection to the data file output device of the vending machine; and
b7) vending to customers as one product choice the data file players.

It is therefore another aspect, advantage, objective, and embodiment of the present invention to provide a method wherein the data file players further comprise MP3 players.

It is therefore another aspect, advantage, objective, and embodiment of the present invention to provide a method wherein the data file players further comprise one member selected from the group consisting of video players, MP4 players, game players, cellular telephones, and combinations thereof.

It is therefore another aspect, advantage, objective, and embodiment of the present invention to provide a method further comprising the steps of:
g) recording a user review of the downloaded data file; and
h) making the user review available to later users.

It is therefore another aspect, advantage, objective, and embodiment of the present invention to provide a method further comprising the step of:
i) providing video advertising on the machine when not in use. further comprising the step of:

It is therefore another aspect, advantage, objective, and embodiment of the present invention to provide a method:
j) offering credit to users of the machine, the credit offered by one member selected from the group consisting of: the commercial entity, the vending management, or combinations thereof.

### BRIEF DESCRIPTION OF THE DRAWINGS

FIG. 1 is a block diagram of the overall system of the invention.

FIG. 2 is a simplified block diagram of a first alternative embodiment of the invention.

FIG. 3 is a simplified block diagram of a second alternative embodiment of the invention.

FIG. 4 is a simplified block diagram of a third alternative embodiment of the invention.

FIG. 5 is a flow chart of a method embodiment of the invention.

FIG. 6 is a flow chart of a second method embodiment of the invention.

### INDEX TO REFERENCE NUMERALS

Reference numerals having alphanumeric suffixes refer to the same part of alternative embodiments. Thus 100, 100a, 100b, 100c are similar parts in different embodiments.

Vending machine 100

Vending management 102

Commercial entity 104

Desired data files source 106

Data file 108

Data file player 110

Coin acceptor 120

Credit device/bill acceptor 122

Touch screen 124

Video softbutton 126

Hardware softbutton 128

Date output device 140

Direct operative connection 142

Mediated operative connection 142′

Programming unit 144

Data handling module/acceptance unit 146

Data player dispenser 148

Download management device/CPU/memory 160

Data player stock 162

Camera 164

Recording control 166

Playback control 168

Optical disk reader 180

Store 200

Point of sale station 202

### DETAILED DESCRIPTION

Reference data vending machines have failed for a number of reasons. The present invention teaches that commercial fundamentals determine the success or failure of such enterprises. For example, high tech culture tends to be enamored of high tech methods of payment such as credit cards, cards having IC chip credit in them, credit accounts in “on-line” “banking” systems and the like. All of these systems pose un-necessary impediments to sales of data files such as music files, audio files, video files, movies, movie trailers, TV episodes, data files and the like. While the overall process is considered high tech, a coin vending device, presently unknown on the market, may be appropriate to sales of products like music which is geared towards young people. In the same vein, music vending machines have not yet provided the music playing devices so as to remove further barriers to commercially viable use by the public.

Another aspect of the “commercial practicality” issue is the failure of reference devices to use the leverage of the vending machine system to secure product promotion, with the income stream generated by selling product placement to vendors of the actual content.

Yet another issue is that the vending device may not need to accept payment at all if it is placed in a secure location analogous to a music store or video store. This also suggests that the music store need carry no expensive stock of music disks if it provides the ability to easily download music files to music player devices and then also provides traditional point of sale station (POS) (“cash register”) convenience to the customer.

The result is that despite a first launch known to the applicant dating back a number of years, there has not previously been a commercially practicable data vending device.

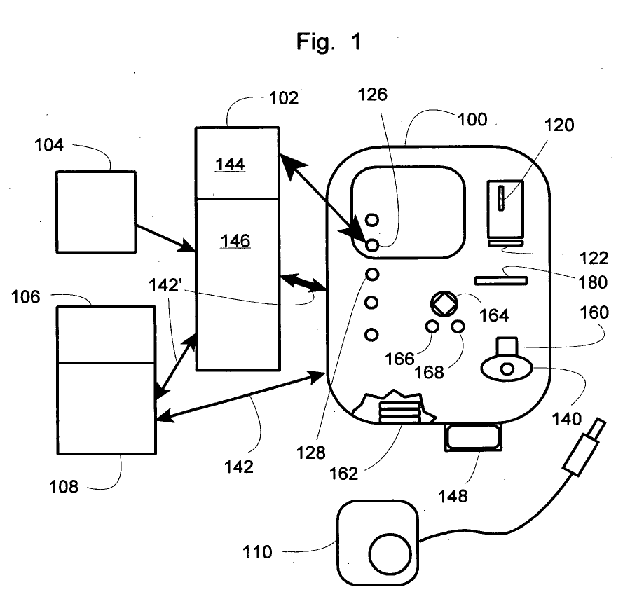

FIG. 1 is a block diagram of the overall system of the invention. The system as pictured may be used to handle a wide variety of data files: MP3, MP4, AAC, WAV, and other format music files, MPG and other format video files, other data files sequential or not, etc. The system works for a wide variety of commercial entities. For example, the commercial entity utilizing the service of the invention may be a record label (for example APPLE™ records), a studio (MGM-UA™), an individual artist or group of artists or performers, a file download service such as iTUNES™ or REAL™, promoters, and so on.

Vending machine 100 may be placed in a public place, preferably a location having high foot traffic passing by. Vending management 102 may be a software device or server located at the site or remotely and having a connection to the machine. In the best mode now contemplated and presently preferred embodiment, vending management device 102 may be located remotely and may oversee an entire network of vending machines 100.

Commercial entity 104 uses vending management 102 to identify desired data files source 106. One example of a desired data files source would be an on-line MP3 download library enterprise which desires to increase its profile and sales by using the promotion method of the invention to increase traffic to that enterprise's own library, thus increasing sales at the expense of the competition. Data file 108 would in such an example be a single music track selected by the user once they have accessed the desired library 106. However, in another case a band promoter commercial entity 104 might desire that user's be directed directly to a desired data files source 106 containing as few as a single data file 108, perhaps a new single for which promotion is greatly desired. A movie studio commercial entity 104 may use the service to show a movie trailer data file 108. In conjunction with promotion by the method of the invention, traditional methods such as discounting the files downloaded by the method, or even offering such files free, may also be employed. A downloaded file may of course have copy protection, a designated life span in hours, etc.

Co-marketing of products may of course be contemplated, and examples of this are easy to embody: “Buy a large hamburger, get a free digital download.” “Only we have the latest song by pop star (name)”, “Downloads $1.00, get a free drink with each download.” Others may be added easily.

Data file player 110 is one already owned by a customer. It has a standard port or jack for receiving downloads. In reference art and in common practice, such players (MP3 players for example) usually receive their downloads from a personal computer which in turn receives them from on-line libraries. A player may be the selected target of the file download, rather than a media device, in order to increase the desirability and instant gratification offered by the device. Thus, while a simple media device such as an optical disk, magnetic disk, memory card or the like may be cheaper to obtain, an actual player provides immediate access to the downloaded file. Such players may be cellular telephones, Bluetooth® devices, game players, video players, PDAs, computers of the sub-notebook size or another size, and so on. These players may be combined with each other and with other devices such as wristwatches, clothing, accessories, purses and bags and so on. The fundamental feature of a “player” as defined herein is that it allows playing/access of the data file, rather than just storing of it.

Coin acceptor 120 provides an inexpensive method of accepting payment for inexpensive products. Thus, a music file costing 49 cents US might easily be purchased by coin payment. Credit device/bill acceptor 122 is further provided for the convenience of those making more expensive purchases such as an entire MP3 player or a large number of songs.

Screen 124 may be a touch screen. It has the user interface function of providing information on using the vending machine and product promotion method of the invention, providing lists, catalogs and libraries of data files to be sold and the like. However, it may also have video softbutton 126 if screen 124 is in fact a touch screen, as contemplated in the preferred embodiment. Hardware softbutton 128 may be a physical button having numbers or arrows indicating which button to push based upon the information displayed on screen 124, for example when screen 124 is not a touchscreen.

For purposes of this invention, a softbutton is defined to be any control whose function may be reprogrammed as desired by the vending management unit 104. Thus, for the duration of a given promotion, the softbutton 126 may be programmed to show users of the device to a given library of music files for download. Should that commercial entity end its promotion, vending management unit 104 may reprogram that button to promote an entirely different product.

Thus, the user may with a “single touch” download a desired date file, if the softbutton is programmed to provide that file immediately upon activation of the switch. This dramatically increases user convenience. The notable inconvenience of MP3 player to personal computers is too well known to require further comment. The vending method and device of the invention, however, provides “one touch” vending of a product.

Of course, the softbuttons may be used to provide more organized access to the libraries the device may have within it or access elsewhere. Thus, one softbutton may be programmed to access music videos, another to access music, a third to access movie trailers and so on. However, this is not the presently preferred embodiment, since this reduces the commercial return and thus commercial viability of the device.

Date output device 140 accepts an operative date connection to the data player 110. This may be a physical data connection, a wireless data connection or the like. Various protocols for wireless applications (for example BLUETOOTH™) may be used,. and similar protocols for wired applications as well. Data output device is normally primarily used for output, however, it may be used for input operations as well, such as reading the identity of a data player attached to it. Note that there may be more than one output device 140, or output device 140 may be able to connect to more than one data player simultaneously. As an example, a BLUETOOTH™ device may well be able to download to five different data players simultaneously.

Direct operative connection 142 may thus be established with “one touch” (or more, depending on the choices of the user) to the data file 108. In the alternative, a mediated operative connection 142′ may be established via data handling module 146 of vending management unit 102.

Programming unit 144 has an operative data connection to vending machine 100, in particular to the data handling module 146, download management device/CPU/memory 160, and importantly, to the softbuttons 126, 128, etc. Programming unit 144 has software and hardware enabling it to reprogram the programmable product placement control when a commercial entity has identified a desired data file source to the acceptance unit 146.

Importantly, data player dispenser 148 may have a data player stock 162 allowing the machine to vend data players such as MP3 players to users. Inexpensive MP3 players may be employed so as to promote sales to individuals who make an impulse purchase of an item of music and require a device capable of attachment to the vending machine 100 to accept the downloaded data file.

The device may also have video camera 164 and the download management device 160 may allow users to record reviews of downloaded products, and may further display upon display 124 those reviews for the benefit or entertainment of later customers. Recording control 166, when activated, allows a user to record a message upon the machine, for example, the review. While the preferred embodiment uses a video camera 164, audio messages may be left instead. Playback control 168 may allow later users to access the recorded review via a playback device such as video screen 124. In the alternative, the device has the necessary structure to serve as a video message center, so the message recorded may be a message to another later user of the machine or even a live message to a user of another machine. Such messages and reviews may also be sent to e-mail, plain old telephone service networks (POTS/PTSN) or the like.

While the device is depicted generally rectangularly, it is understood that the shape is not shown in the block diagrams. One alternative preferred embodiment of the invention teaches a pole (cylindrical) shaped device having eye-catching esthetics such as a metallized exterior, or an exceptionally large display 124 allowing the device to function as a video billboard when not in use, etc.

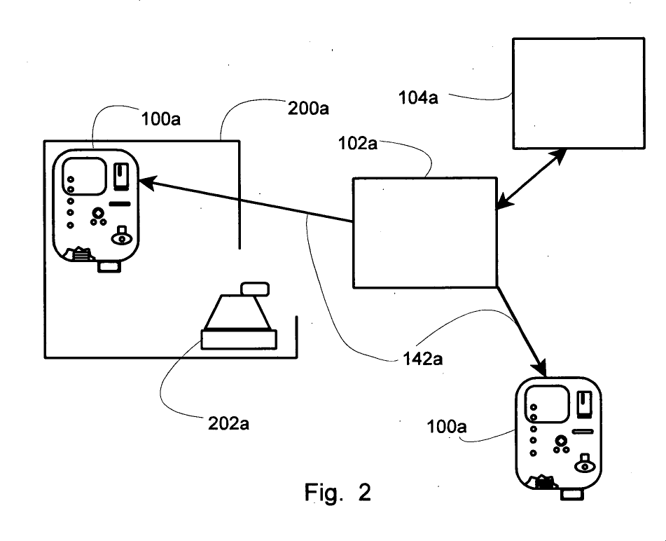

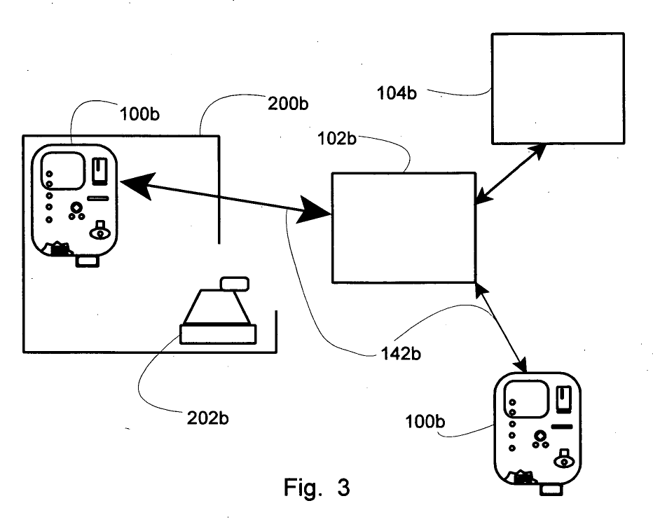

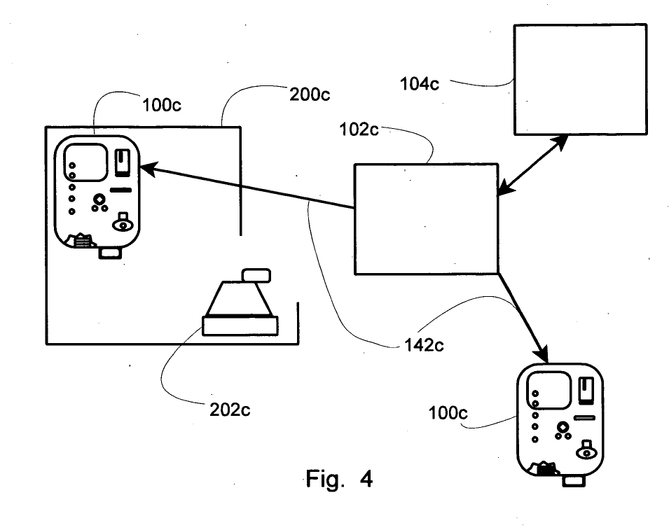

FIG. 2 is a simplified block diagram of a first alternative embodiment of the invention. FIG. 3 is a simplified block diagram of a second alternative embodiment of the invention. FIG. 4 is a simplified block diagram of a third alternative embodiment of the invention.

Store 200 may have traditional point of sale station 202 (a cash register), as well as vending machine 100. In the embodiment of FIG. 2, the vending machine 100a is connected directly by data connection 142a to the desired data source 106a of commercial entity 104a, as enabled by vending management unit 102a. This embodiment may teach a music store 200a in which customers and vending machines connect directly to the library of, for example, a music download service but pay at POS 202a.

In the embodiment of FIG. 3, however, data connection 142b connects vending machine 100b to vending management 102b, from which the download arrives. Thus in this embodiment, vending management handles the actual data library accessed by the vending machines 100b. Store 200b and POS 202b may be as described previously, or the POS 202b may enable the operative connections prior to downloads (“pay first”). Commercial entity 104c may be as previously described.

In the embodiment of FIG. 4, desired data files are in fact stored in the actual vending machine 100c. Thus the commercial entity 104c provides this content to the vending management unit 102c which in turn reprograms the CPU/memory/download management module of the vending machine 100c to actually retain the data file at the vending machine location in a public location or in a store 200c having a POS 202c.

In one alternative embodiment, the data output device may be an optical disk writer or an e-mail device allowing the data file downloaded to actually be sent to yet another location. As is known in the art, the vending machine may track user preferences by individual or group and then make suggestions for compatible downloads.

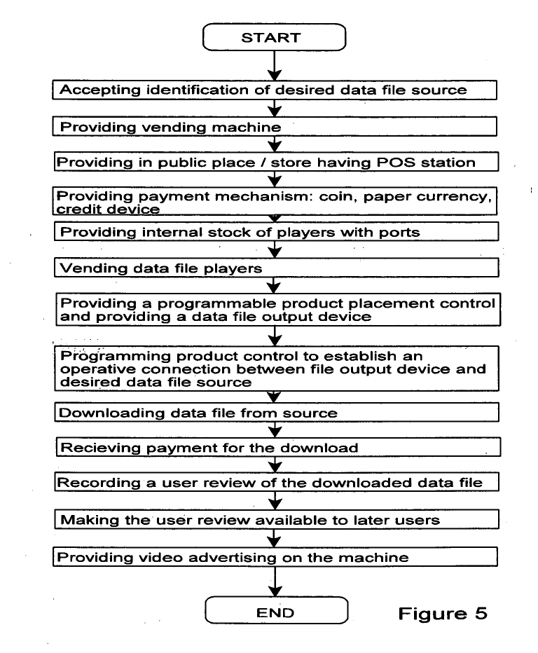

FIG. 5 is a flow chart of a method embodiment of the invention. The steps of the invention may be:
a) accepting from such commercial entity identification of such desired data file source;
b) providing a vending machine;
b2) providing the vending machine in a public place; or b2a) providing the vending machine in a store having a point of sale station,
b3) providing the vending machine with a payment mechanism capable of accepting coins, or b4) paper currency, or b5) a credit device;
b6) providing the vending machine with an internal stock of data file players having ports allowing operative data connection to the data file output device of the vending machine; and
b7) vending to customers as one product choice the data file players.
c) providing upon the vending machine a programmable product placement control and a data file output device;
d) programming the programmable product placement control to establish an operative connection between the data file output device and the desired data file source when activated;
e) downloading at least one data file from the desired data file source to the data output device;
f) receiving payment for the download;
g) recording a user review of the downloaded data file; and
h) making the user review available to later users;
i) providing video advertising on the machine when not in use.

The ordering of the steps is not crucial, breaking down into several overall phases:
i) PROVIDING an appropriate machine in the appropriate place;
ii) ACCEPTING product promotion identification from commercial entities;
iii) REPROGRAMMING softbuttons to provide quick or instant or convenient access to the identified product;
iv) SELLING/DOWNLOADING products to clients, along with sale of data players;
v) GATHERING consumer information.

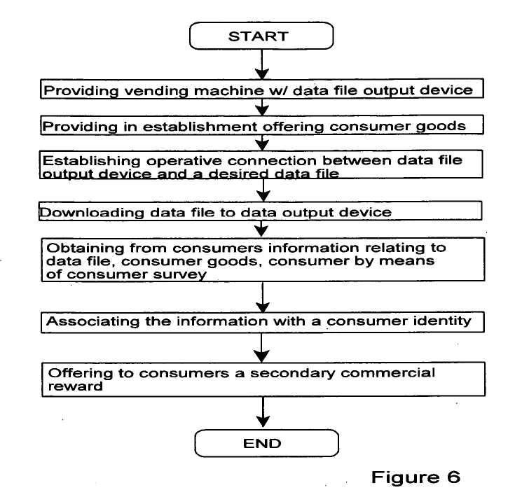

FIG. 6 is a flow chart of an embodiment of the invention. The steps of the invention may be:
a) providing to such consumers a vending machine having a data file output device;
a1) providing such vending machine at an establishment offering consumer goods
b) establishing an operative connection between the data file output device and a desired data file
c) downloading the desired data file to the data output device; and
d) obtaining from such consumers information
d1) obtaining from such consumers information specifically relating to the data file downloaded or d2) obtaining from such consumers information specifically relating to the consumer goods of the establishment or d3) obtaining from such consumers information specifically relating to such consumer
d4) obtaining such information by means of a consumer survey
e) associating such information with a specific consumer identity
f) offering to such consumer a secondary commercial reward Thus, the machine may be used to gather information from the consumer. In an embodiment in which the offer of a digital download is associated with the offer of a product such as a particular type of coffee or hamburger, the gathering of such information may in fact be automatic: the provision of an access code by the commercial establishment automatically provides tracking of the fact that consumers ordering the file were the same consumers ordering a particular consumer good.

The information may also be gathered by surveying the customer with the customer's knowledge and consent, for example, by asking the consumer to answer questions. An additional or secondary commercial reward may be offered to assist with this gathering, i.e. a coupon good for either additional file downloads or for a consumer good of the establishment. This is referred to as a secondary commercial reward because the primary commercial reward to the consumer is the co-marketed products of download file and consumer good. The secondary commercial reward may of course be an actual download or consumer good, and may be omitted in systems in which provision of such information is necessary to obtain the digital download file at all.

Such information may be associated with a specific consumer identification such as name, customer number or the like.

Information gathered may be of any type. Obviously, it may concern the consumer themself: name, age, gender, income, spending habits, employment, personal taste in music, preferences in electronic goods or other consumer goods, knowledge of products and services, etc. However, the information gathered may also concern digital files: identity of the desired file and of other desired files, favorite sources of digital files (musical groups, musicians, recording studios, on-line services, etc). It may also advantageously concern the preferences of the consumer in regard to the goods/services of the commercial establishment. Thus a restaurant might query consumers regarding their appreciation of various items of food or drink, their taste in restaurants, reasons for making a purchase and so on. This last type of information may make the invention highly valuable to commercial establishments.

The machine may also provide video advertising when not in use. Obviously, while screen 124 has been depicted fairly small and single, it may be large enough to function as a video billboard in addition to the user's control device, or another larger screen may be provided, etc. The machine itself may advertise the co-marketing arrangement or the desired digital file.

The machine may also have an optical disk reader 180 able to read a data file from an optical disk, the download management module being operative to download the data file read from the optical disk to the data output device. By this means, a user may transfer a data file from an optical disk to the data player, for example a music track from a CD to an MP3. The download management module may also be operative to charge a royalty fee or other fee when the user makes a transfer of a file from an optical disk to a data player.

In another embodiment, the server portion of the device, the commercial entity, or the vending management may maintain a credit for clients, allowing users to access the vending machine on that credit. Such a credit could be a monthly allowance or otherwise a present from a a party other than the actual user, for example, a $20 USD per month credit for downloads provided by a parent to a child. The credit may be provided via the vending machine's credit reader, or via an on-line or telephone service.

Another significant inventive step in that the commercial entity may function as the credit provider, thus allowing user's transactions to “pass through” the vending machine without payment to or accounting by the vending management, and yet allow the ease of credit purchases of data files.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of gathering information from consumers, comprising the steps of:
a) providing to such consumers a vending machine having a data file output device;
b) establishing an operative connection between the data file output device and a desired data file;
c) downloading the desired data file to the data output device; and
d) obtaining from such consumers information.

2. The method of claim 1, further comprising the step of:
d1) obtaining from such consumers information specifically relating to the data file downloaded.

3. The method of claim 1, further comprising the step of:
a1) providing such vending machine at an establishment offering consumer goods;
d2) obtaining from such consumers information specifically relating to the consumer goods of the establishment.

4. The method of claim 1, further comprising the step of:
d3) obtaining from such consumers information specifically relating to such consumer.

5. The method of claim 1, further comprising the step of:
d4) obtaining such information by means of a consumer survey.

6. The method of claim 1, further comprising the step of:
e) associating such information with a specific consumer identity.

7. The method of claim 1, further comprising the step of:
f) offering to such consumer a secondary commercial reward.

8. A method of promoting a desired data file source from a commercial entity, comprising:
a) accepting from such commercial entity identification of such desired data file source;
b) providing a vending machine;
c) providing upon the vending machine a programmable product placement control and a data file output device;
d) programming the programmable product placement control to establish an operative connection between the data file output device and the desired data file source when activated; and
e) downloading at least one data file from the desired data file source to the data output device.

9. The method of claim 8, further comprising the step of:
b2) providing the vending machine in a public place.

10. The method of claim 8, further comprising the steps of:
b2a) providing the vending machine in a store having a point of sale station,
f) receiving payment for the download.

11. The method of claim 9, further comprising the step of:
b3) providing the vending machine with a payment mechanism capable of accepting coins.

12. The method of claim 10, further comprising the step of:
b4) providing the vending machine with a payment mechanism capable of accepting paper currency.

13. The method of claim 11, further comprising the step of:
b5) providing the vending machine with a payment mechanism capable of accepting credit on devices scanned by the payment mechanism.

14. The method of claim 12, further comprising the steps of:
b6) providing the vending machine with an internal stock of data file players having ports allowing operative data connection to the data file output device of the vending machine; and
b7) vending to customers as one product choice the data file players.

15. The method of claim 14, wherein the data file players further comprise MP3 players.

16. The method of claim 14, wherein the data file players further comprise one member selected from the group consisting of video players, MP4 players, game players, cellular telephones, and combinations thereof.

17. The method of claim 8, further comprising the steps of:
g) recording a user review of the downloaded data file; and
h) making the user review available to later users.

18. The method of claim 8, further comprising the step of:
i) providing video advertising on the machine when not in use.

19. The method of claim 8, further comprising the step of:
j) offering credit to users of the machine, the credit offered by one member selected from the group consisting of: the commercial entity, the vending management, or combinations thereof.
